(19) United States
(12) Patent Application Publication
(10) Pub. No.: US 2005/0150517 A1
(43) Pub. Date: Jul. 14, 2005

(54) Removing discoloration in heated metal using vinegar

(76) Inventor: James R. Powers, Santa Fe, TX (US)

Correspondence Address: James R. Powers, PO Box 113, Santa Fe, TX, 77510, US

(21) Appl. No.: 10/707,753

(22) Filed: Jan. 9, 2004

(51) Int. Cl. B08B 3/04

(52) U.S. Cl. 134/2

(57) ABSTRACT

A process for removing discoloration from metal parts due to the heating of these parts.

### BACKGROUND OF INVENTION

Metal that has been heated, such as collars and bearing races leaves discoloration in the metal. This required somebody to spend countless time trying to remove the discoloration using some sort of abrasive cloth, which could change the size of the finished product.

Accordingly, a need exists for a way to remove these marks without adversely affecting the part itself.

### SUMMARY OF INVENTION

The invention includes the use of distilled white vinegar as a cleaner to remove the unwanted marking on the metal that are caused by heat.

### DETAILED DESCRIPTION

The invention is standard distilled white vinegar used as a cleaner to remove the discoloration from the metal that is caused by heat. When finished with the metal object, let it cool to normal handling temperature, apply the vinegar either to a rag or directly to the object and wipe of the discoloration.

1. A cleaner that can remove the discoloration in metal caused by the heating of the metal which is comprised of distilled white vinegar.
